(19) United States
(12) Patent Application Publication
(10) Pub. No.: US 2009/0316230 A1
(43) Pub. Date: Dec. 24, 2009

(54) IMAGE FORMING DEVICE AND EXPOSURE APPARATUS

(75) Inventors: Tetsurou Nakamura, Hyogo (JP); Yuuji Toyomura, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/915,867

(22) PCT Filed: May 25, 2006
(86) PCT No.: PCT/JP2006/310480

§ 371 Date: Nov. 29, 2007

(30) Foreign Application Priority Data
May 30, 2005 (JP) 2005-156800

(51) Int. Cl. H04N 1/04

(52) U.S. Cl. 358/475

(57) ABSTRACT

An exposure apparatus for an image forming apparatus is provided, the exposure apparatus being downsized by reducing the substrate on which a row of light emitting elements are provided in size in the sub-scanning direction. The exposure apparatus comprises a glass substrate, a row of light emitting elements constituted by multiple organic EL elements on the glass substrate, and a drive control unit for receiving from outside the glass substrate control signals for driving the organic EL elements and controlling the drive of the light emitting elements based on the control signals, wherein the drive control unit is at least partly placed on the extended line of the row of light emitting elements.

### TECHNICAL FIELD

The present invention relates to an exposure apparatus having a row of light emitting elements constituted by fine light emitting elements linearly arranged and an image forming apparatus carrying the exposure apparatus.

### BACKGROUND ART

In an image forming apparatus utilizing the so-called electrophotography process, a photosensitive body is charged to a given potential and exposed according to image information to form an electrostatic latent image; the latent image is developed using a toner; and the visualized toner image is transferred to a recording paper and fixed there to obtain an image. The exposure apparatus used in such an image forming apparatus utilizes a system in which the photosensitive body is scanned with a light beam emitted from a laser diode via a rotary multifaceted mirror called a polygon mirror or a system in which a row of light emitting elements is constituted by linearly arranging light emitting elements consisting of light emitting diodes or an organic EL material and the light emitting parts are individually turned on (off) to form an electrostatic latent image on the photosensitive body.

Generally, an exposure apparatus having a row of light emitting elements consisting of LEDs or an organic material as a component selectively turns on the light emitting elements near the photosensitive body to expose the photosensitive body to the exposure light. Therefore, the printers having such elements do not have movable members such as the rotary multifaceted mirror in laser printers, and are very reliable and quiet. Furthermore, they do not require an optical system to guide the light from the laser diode to the photosensitive body or a large space for the optical path, enabling the image forming apparatus to be downsized.

Particularly, an exposure apparatus carrying organic EL elements as the light emitting element is constructed by integrating a drive circuit consisting of switching elements formed by a thin-film transistor (hereafter referred to as a TFT) with organic EL elements on a glass substrate. Therefore, such an exposure apparatus is simple in structure and production process and possibly further downsized and produced at lower cost compared to the exposure apparatus carrying LEDs as the light emitting element (hereafter referred to as an LED head).

Some convention LED heads have structures described for example in Patent Documents 1 and 2 and some recording devices in which recording elements are linearly arranged have the structure described for example in Patent Document 3.

FIG. 13 is a perspective view showing the structure of a prior art exposure apparatus. First, the structure of a prior art exposure apparatus described in Patent Document 1 is described with reference to FIG. 13. The exposure apparatus in FIG. 13 comprises a glass substrate 130, a vacuum chamber 131, and IC chips 132 for driving the light emitting elements. The row of light emitting elements 133 is sealed in the vacuum chamber 131 and is not visible from outside. Patent Document 1 discloses an exposure apparatus having negative electrodes facing multiple anode electrodes, on the surface of which the fluorescent light emitting elements 133 are attached and grid electrodes interposed between the negative electrodes and the anode electrodes in the vacuum chamber 131 on the glass substrate 130. Here, the direction in which the row of light emitting elements 133 is oriented is defined as the main scanning direction and the direction orthogonal to the main scanning direction on the glass substrate is defined as the sub-scanning direction. The multiple IC chips 132 are arranged along the row of light emitting elements 133 or in parallel to the row of light emitting elements 133 in the main scanning direction. Therefore, the IC chips 132 are spaced from the row of light emitting elements 133 in the sub-scanning direction.

Patent Document 2 discloses a structure in which the row of light emitting elements and IC chips for driving them are connected via a matrix circuit. In order to connect the electrode pads connected to the matrix circuit and the IC chips by wire bonding, the IC chips are spaced from the row of light emitting elements in the sub-scanning direction as in Patent Document 1.

As described above, the IC chips for driving the individual light emitting elements constituting the row of light emitting elements are arranged along and in parallel to the row of light emitting elements in the prior art, because the IC chips for driving the light emitting elements directly supply a current to the light emitting elements and the wiring distance should be minimized to reduce the influence of line capacitance and line resistance.

Patent Document 3 discloses the structure of a thermal print head, which is a recording device. In the recording device in which the exposure apparatus and recording elements such as thermal heads are linearly arranged, the IC chips for driving the recording elements are generally divided into multiple groups and image data are often independently transferred to each group. Therefore, the interface for supplying image data to the IC chips from an external source is formed on the opposite side of the multiple IC chips to the row of recording elements, namely at the farthest end of the substrate in the width direction (the sub-scanning direction) so that no significant difference is created in the wiring distance to the multiple IC chips.

[Patent Document 1] Japanese Unexamined Patent Publication No. H03-213362;

[Patent Document 2] Japanese Unexamined Patent Publication No. H11-40842; and

[Patent Document 3] Japanese Unexamined Patent Publication No. H11-188906.

### SUMMARY OF THE INVENTION

When the IC chips for driving the light emitting elements are placed in parallel to the row of light emitting elements as in the exposure apparatuses disclosed in Patent Documents 1 and 2, the IC chips for controlling the drive of the row of light emitting elements has to be arranged in the direction (the sub-scanning direction) orthogonal to the longitudinal direction (the main scanning direction) of the substrate installed in the exposure apparatus. Furthermore, when the external interface for supplying signals to the IC chips is placed in parallel to the row of light emitting elements as disclosed in Patent Document 3, the substrate is increased in size in the sub-scanning direction. Therefore, the exposure apparatus is increased in size and, consequently, the image forming apparatus in which the exposure apparatus is mounted is increased in size.

The image forming apparatus of the present invention is proposed in view of the above problems and is an image forming apparatus carrying an exposure apparatus wherein the exposure apparatus has a substrate, a row of light emitting elements constituted by a plurality of light emitting elements on the substrate, and a drive control unit configured to receive from outside the substrate a control signal for driving the plurality of light emitting elements and control the drive of the plurality of light emitting elements based on the control signal, wherein the drive control unit is at least partly placed on the extended line of the row of the light emitting elements.

According to the image forming apparatus of the present invention, the drive control unit configured to control the drive of the light emitting elements is at least partly placed on the extended line of the row of the light emitting elements in the exposure apparatus and, therefore, the substrate of the exposure apparatus is reduced in size in the sub-scanning direction, by which the exposure apparatus is downsized and particularly flattened. Using the flattened exposure apparatus, the image forming apparatus can be downsized.

### BRIEF DESCRIPTION OF THE DRAWINGS

FIG. 1 is an illustration showing the image forming apparatus of the first embodiment of the present invention.

FIG. 2 is an illustration showing the developing station and its vicinity in the image forming apparatus of the first embodiment.

FIG. 3 is an illustration showing the structure of the exposure apparatus in the image forming apparatus of the first embodiment.

FIG. 4A is a top view of the glass substrate of the exposure apparatus in the image forming apparatus of the first embodiment and FIG. 4B is an enlarged view of the core part of the same.

FIG. 5 is an illustration showing the geometry of the organic EL elements in the image forming apparatus of the first embodiment.

FIG. 6 is a circuit diagram of the exposure apparatus in the image forming apparatus of the first embodiment.

FIG. 7 is an illustration for explaining the current program time and organic EL element turn-on time of the exposure apparatus in the image forming apparatus of the first embodiment.

FIG. 8 is a cross-sectional view of the organic EL element of the exposure apparatus in the image forming apparatus of the first embodiment.

FIG. 9 is a top view of the organic EL element of the exposure apparatus in the image forming apparatus of the first embodiment.

FIG. 10A is a top view of the glass substrate of the exposure apparatus in the image forming apparatus of the second embodiment and FIG. 10B is an enlarged view of the core part of the same.

FIG. 11 is an illustration showing a structure of the source driver signal line.

FIG. 12 is an illustration showing a structure at the crossing point of signal lines.

FIG. 13 is a perspective view showing the structure of a prior art exposure apparatus.

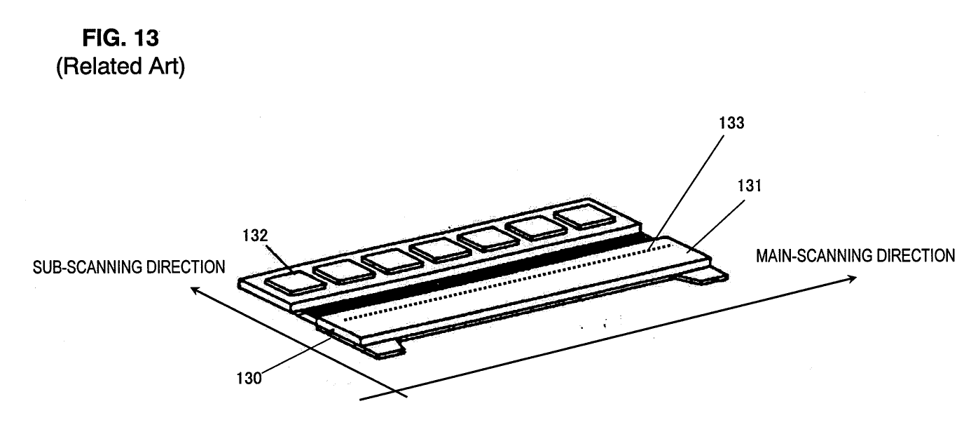

### DETAILED DESCRIPTION OF THE INVENTION

The image forming apparatus or exposure apparatus provided according to various aspects of the present invention are described hereafter with reference to the drawings.

According to one aspect of the present invention, an image forming apparatus having an exposure apparatus is provided. The exposure apparatus comprises: a substrate; a light emitting elements row containing a plurality of light emitting elements on the substrate; and a drive control unit configured to receive from outside the substrate a control signal for driving the plurality of light emitting elements and control the drive of the plurality of light emitting elements based on the control signal, wherein the drive control unit is at least partly placed on the extended line of the light emitting elements row. In this way, the substrate of the exposure apparatus is reduced in size in the sub-scanning direction and, therefore, the exposure apparatus is downsized and particularly flattened, enabling the image forming apparatus carrying the exposure apparatus to be downsized.

In this image forming apparatus, the drive control unit can at least comprise an interface unit configured to receive a control signal from outside the substrate and an IC chip configured to control the drive of the plurality of light emitting elements based on the control signal received by the interface unit. The drive control unit is partly placed on the extended line of the light emitting elements row. In this way, the substrate of the exposure apparatus is reduced in size in the sub-scanning direction and, therefore, the exposure apparatus is downsized and particularly flattened, by which enabling the image forming apparatus carrying the exposure apparatus to be downsized.

In a preferred embodiment, the drive control unit is placed without overlapping with the light emitting element row in the direction of the light emitting elements row in the direction of the light emitting elements row. In this way, the substrate of the exposure apparatus is reduced in size in the sub-scanning direction and, therefore, the exposure apparatus is downsized and particularly flattened, downsizing enabling the image forming apparatus carrying the exposure apparatus to be downsized.

The drive control unit can be placed on the extended line of the light emitting elements row at an end of the substrate. In this way, the substrate of the exposure apparatus is reduced in size in the sub-scanning direction and, therefore, the exposure apparatus is downsized and particularly flattened, enabling the image forming apparatus carrying the exposure apparatus to be downsized.

According to another aspect of the present invention, an image forming apparatus having an exposure apparatus is provided. The exposure apparatus comprises a substrate; a light emitting elements row containing a plurality of light emitting elements on the substrate; a drive circuit provided on the substrate and configured to supply a drive current to each of the plurality of light emitting elements of the light emitting elements row; a drive parameter setting unit provided on the substrate and configured to a drive parameter for driving the light emitting elements in the drive circuit; and an interface unit provided on the substrate and coupled to the drive parameter setting unit configured to supply the drive parameter to the drive parameter setting unit from outside the substrate, wherein at least either the drive parameter setting unit or the interface unit is placed on the extended line of the light emitting elements row. In this way, the substrate of the exposure apparatus is reduced in size in the sub-scanning direction and, therefore, the exposure apparatus is downsized and particularly flattened, enabling the image forming apparatus carrying the exposure apparatus to be downsized.

In this image forming apparatus, the drive circuit for the light emitting elements can be a TFT (thin-film transistor). In this way, the multilayer wiring is realized on the substrate and the substrate is reduced in size in the sub-scanning direction and, therefore, the exposure apparatus is downsized and particularly flattened, enabling the image forming apparatus carrying the exposure apparatus to be downsized.

In a preferred embodiment, the drive parameter setting unit is placed without overlapping with the light emitting elements row or the drive circuit in the direction of the light emitting elements row. In this way, the substrate of the exposure apparatus is reduced in size in the sub-scanning direction and, therefore, the exposure apparatus is downsized and particularly flattened, enabling the image forming apparatus carrying the exposure apparatus to be downsized.

The drive parameter setting unit of the exposure apparatus carried by the image forming apparatus can be an IC chip and the IC chip is mounted on the extended light of the light emitting elements row. With the IC chip being not placed in parallel to the light emitting elements row, the substrate is reduced in size in the sub-scanning direction and, therefore, the exposure apparatus is downsized and particularly flattened, enabling the image forming apparatus carrying the exposure apparatus to be downsized.

In a preferred embodiment, the drive parameter setting unit of the exposure apparatus carried by the image forming apparatus sets in the drive circuit a current value for driving the light emitting elements. In this way, the exposure apparatus is downsized and flattened, and the light emitting elements have uniform luminance.

It is preferable that the substrate at least has a long side and a short side and the light emitting elements row is arranged in the long side direction of the substrate. In this way, a necessary number of light emitting elements for exposure are arranged on the substrate and the substrate of the exposure apparatus is reduced in size in the sub-scanning direction and, therefore, the exposure apparatus is downsized and particularly flattened, enabling the image forming apparatus carrying the exposure apparatus to be downsized.

In the image forming apparatus, the light emitting elements can be organic EL elements. In this way, fine light emitting elements can easily be formed on the substrate on which thin-film transistors are previously formed. Then, the substrate is reduced in size in the sub-scanning direction and, therefore, the exposure apparatus is downsized and particularly flattened, enabling the image forming apparatus carrying the exposure apparatus to be downsized.

The substrate can be a transparent glass substrate and light emitted from the light emitting elements on the substrate is transmitted through the transparent substrate before output. In this way, the production process of the light emitting elements is simplified and high production yield of the substrate can be maintained even if the substrate is reduced in size in the sub-scanning direction.

Furthermore, the interface unit configured to supply the control signal to the substrate from an external source can be placed without overlapping the light emitting elements row or the drive circuit in the direction of the light emitting elements row. In this way, the substrate of the exposure apparatus is reduced in size in the sub-scanning direction and, therefore, the exposure apparatus is downsized and particularly flattened, enbling the image forming apparatus carrying the exposure apparatus to be downsized.

The interface unit configured to supply the control signal to the substrate from the external source can directly be mounted on the surface of the substrate. In this way, extra members such as connectors can be eliminated for reduced cost and the substrate is reduced in size in the sub-scanning direction and, therefore, the exposure apparatus is downsized and particularly flattened, enabling the image forming apparatus carrying the exposure apparatus to be downsized.

The interface unit configured to supply the control signal to the substrate from the external source can be placed on the extended line of the light emitting elements row at the farthest point of the substrate. In this way, the space on the substrate is effectively used. Then, the entire substrate is reduced in size and, therefore, the exposure apparatus is downsized and particularly flattened, enabling the image forming apparatus carrying the exposure apparatus to be downsized.

According to still another aspect the present invention, an image forming apparatus is provided. The image forming apparatus comprises: a light emitting elements row containing a plurality of light emitting elements linearly arranged; a drive circuit configured to supply a drive current to each of the plurality of light emitting elements of the light emitting elements row; an IC chip configured to set a drive current value in the drive circuit based on multi-value light amount correction data for equalizing the luminance of the plurality of light emitting elements; a light emitting control circuit configured to control the turn-on/turn-off of the light emitting elements based on binary image data; a flexible print circuit configured to supply light amount correction data and image data to the IC chip and light emitting control circuit; and a rectangular substrate on which connections to the light emitting elements row, IC chip, and flexible print circuit are linearly arranged in the long side direction of the substrate. In this way, the substrate of the exposure apparatus is reduced in size in the sub-scanning direction and, therefore, the exposure apparatus is downsized and particularly flattened, enabling the image forming apparatus carrying the exposure apparatus to be downsized. In this image forming apparatus, the light emitting elements are turned on/off based on binary image data. The drive current value does not need to be reset each time it is set. Therefore, the time required to set the drive current value for each light emitting element is saved. The IC chip and light emitting elements row are arranged in the long side direction of the substrate. Even if the wiring distance from the IC chip to some light emitting elements is increased, no inconvenience occurs in setting the drive current value for these light emitting elements. The drive current value is easily set for the other light emitting elements because the IC chip is provided on the substrate.

In a preferred embodiment, the substrate is housed in a housing having a housing member. The housing member has an L-shaped part. The substrate is attached to and supported by one surface of the L-shaped part. A lens array is attached to another surface of the L-shaped part that is orthogonal to the support surface. Besides the substrate, the housing can house a relay substrate for connecting to the flexible print circuit a controller having a light amount correction data memory storing light amount correction data and an image memory storing image data.

According to still another aspect of the present invention, an exposure apparatus is provided. The exposure apparatus comprises: a substrate; a light emitting elements row containing a plurality of light emitting elements on the substrate; and a drive control unit configured to receive from outside the substrate control signal for driving the light emitting elements and control the drive of the light emitting elements based on the control signal, wherein the drive control unit is at least partly placed on the extended line of the light emitting elements row. In this way, the substrate of the exposure apparatus is reduced in size in the sub-scanning direction, whereby the exposure apparatus is downsized and particularly flattened.

According to still another aspect of the present invention, an exposure apparatus is provided. The exposure apparatus comprises a substrate; a light emitting elements row containing by a plurality of light emitting elements on the substrate; a drive circuit provided on the substrate and configured to supply a drive current to each of the plurality of light emitting elements of the light emitting elements row; a drive parameter setting unit provided on the substrate and configured to set in the drive circuit a drive parameter for driving the light emitting elements; and an interface unit provided on the substrate, coupled to the drive parameter setting unit, and configured to supply to the drive parameter setting unit the drive parameter from outside the substrate, wherein at least either the drive parameter setting unit or the interface unit is placed on the extended line of the light emitting elements row. In this way, the substrate of the exposure apparatus is reduced in size in the sub-scanning direction, whereby the exposure apparatus is downsized and particularly flattened.

### FIRST EMBODIMENT

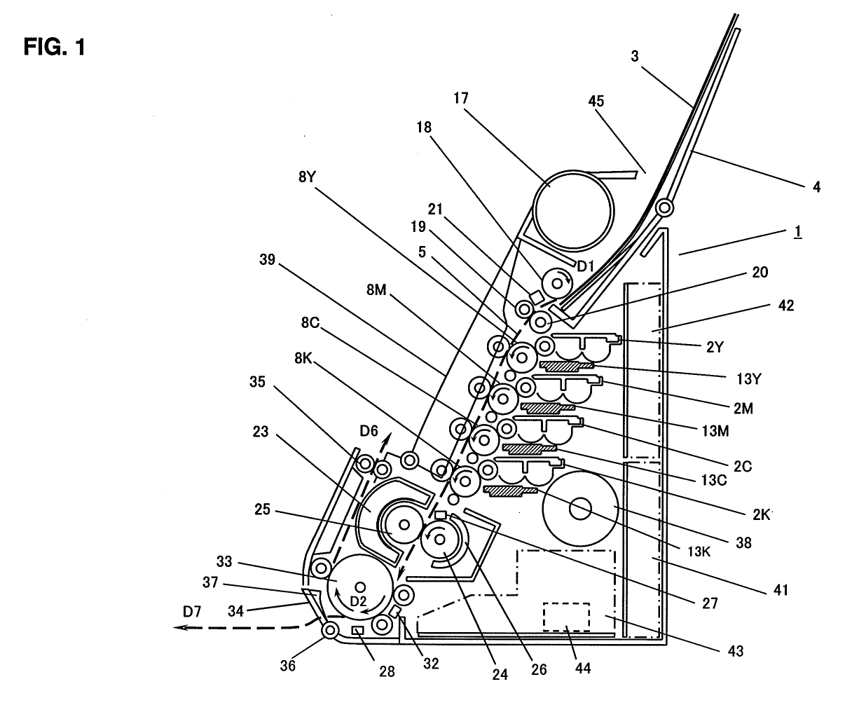

FIG. 1 is an illustration showing the structure of the image forming apparatus of the first embodiment.

In the image forming apparatus 1 of FIG. 1, four color developing stations, a yellow developing station 2Y, a magenta developing station 2M, a cyan developing station 2C, and a black developing station 2K, are arranged vertically stepwise and, above them, a paper feed tray 4 is provided for placing a recording paper 3. A recording paper path 5 through which the recording paper 3 supplied from the paper feed tray 4 is passed is defined vertically from top down along the developing stations 2Y to 2K.

The developing stations 2Y to 2K are used to form yellow, magenta, cyan, and black toner images from the upstream of the recording paper path 5. The yellow developing station 2Y has a photosensitive body 8Y; the magenta developing station 2M has a photosensitive body 8M; the cyan developing station 2C has a photosensitive body 8C; and the black developing station 2K has a photosensitive body 8K. Furthermore, the developing stations 2Y to 2K each have a not-shown series of members for realizing the developing process such as a developing sleeve and a charger.

Exposure apparatus 13Y, 13M, 13C, and 13K for exposing the surfaces of the photosensitive bodies 8Y to 8K to form electrostatic latent images are provided below the developing stations 2Y to 2K, respectively.

Though they are filled with different color developing agents, the developing stations 2Y to 2K have the same structure. Therefore, for simplified explanation, those members are collectively described hereafter without specifying the color, such as the developing station 2, photosensitive body 8, and exposure apparatus 13, unless the colors should be distinguished.

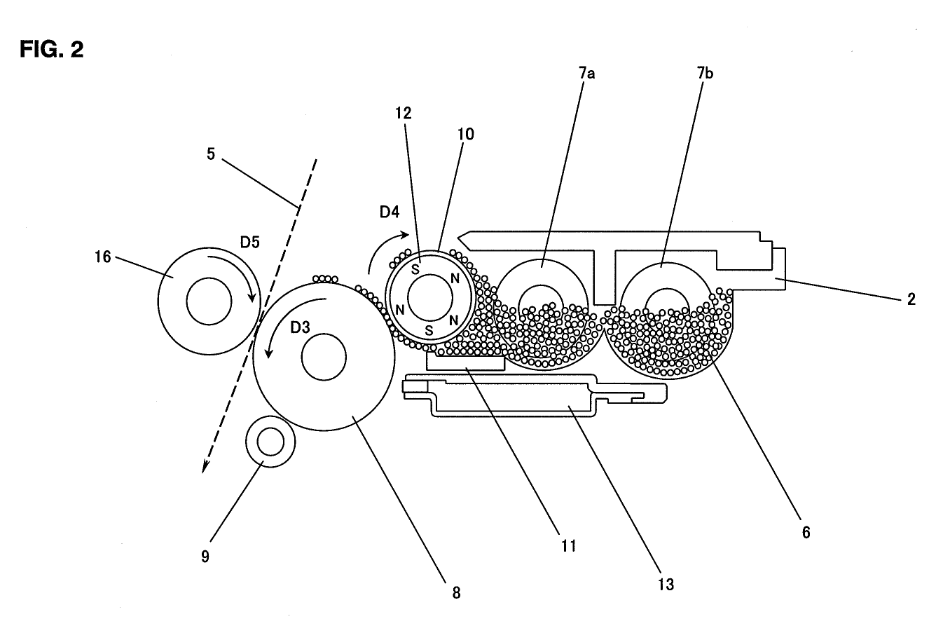

FIG. 2 is an illustration showing the developing station 2 and its vicinity in the image forming apparatus 1 of the first embodiment. In FIG. 2, the developing station 2 is filled with a developing agent 6 that is a carrier/toner mixture. Stirring paddles 7a and 7b are used to stir the developing agent 6. The rotation of the stirring paddles 7a and 7b causes friction between the toner and carrier in the developing agent 6, whereby the toner is charged to a given potential. In addition, the toner is circulated within the developing station 2 and sufficiently mixed with the carrier. The photosensitive body 8 is rotated in the direction 2D by a not-shown drive source. A charger 9 charges the surface of the photosensitive body 8 to a given potential. A developing sleeve 10 contains a mag-roll 12 having multiple magnetic poles. A thinning blade 11 defines the thickness of a layer of the developing agent 6 supplied to the surface of the developing sleeve 10. The developing sleeve 10 is rotated in the direction D4 by a not-shown drive source. This rotation and the magnetic effect of the mag-roll 12 serve to supply the developing agent 6 to the surface of the developing sleeve 10. Then, an electrostatic latent image formed on the photosensitive body 8 by the exposure apparatus described later is developed. Some developing agent 6 that is not transferred to the photosensitive body 8 is recovered into the developing station 2.

The exposure apparatus 13 of this embodiment contains organic EL elements linearly arranged at a resolution of 600 dpi (dots/inch). For the photosensitive body 8 charged to a given potential by the charger 9, the organic EL elements are selectively turned on/off according to image data to form an electrostatic latent image in a maximum size of A4. Only the toner in the developing agent 6 supplied to the surface of the developing sleeve 10 adheres to the electrostatic latent image, whereby the electrostatic latent image is visualized.

A transfer roller 16 is provided on the other side of the recording paper path 5 at a position corresponding to the photosensitive body 8 and rotated in the direction D5 by a not-shown drive source. A given transfer bias is applied to the transfer roller 16, whereby the toner image formed on the photosensitive body 8 is transferred to a recording paper supplied along the recording paper path 5.

Referring back to FIG. 1, further explanation is made hereafter.

As described above, the image forming apparatus 1 of this embodiment is a tandem-type color image forming apparatus in which multiple developing stations 2Y to 2K are arranged vertically stepwise and is intended to be in the same class as color inkjet printers in terms of size. The developing stations 2Y to 2K each contain multiple units. Therefore, in order to downsize the image forming apparatus 1, the developing stations 2Y to 2K themselves have to be downsized and the members provided around the developing stations 2Y to 2K for executing the image forming process have to be made smaller to reduce the distance between the developing stations 2Y to 2K.

Considering the convenience of the image forming apparatus 1 to the users when it is placed on the desktop in their office, particularly the accessibility to the recording paper 3 for placing or retrieving the paper, the height of the paper feed opening 45 from the bottom of the image forming apparatus 1 is desirably 250 mm or smaller. In order to realize this, the developing stations 2Y to 2K have to have a total height reduced to approximately 100 mm in the entire structure of the image formation apparatus 1.

However, for example, the existing LED head has a thickness of approximately 15 mm. If such LED heads are placed between the developing stations 2Y to 2K, it is difficult to achieve the above target. According to examinations of the inventors of the present invention, when the exposure apparatus 13 has a thickness of 7 mm or smaller, the developing stations 2Y to 2K can have a total height reduced to 100 mm or smaller after the exposure apparatus 13Y to 13K are interposed between them.

Toner bottles 17 contain yellow, magenta, cyan, and black toners, respectively. Not-shown toner supply pipes are provided from the toner bottles 17 to the respective developing stations 2Y to 2K to supply the toners to the respective developing stations 2Y to 2K.

A paper feed roller 18 is rotated in the direction Dl by a not-shown electromagnetic clutch to urge the recording paper 3 on the paper feed tray 4 to the recording paper path 5.

A pair of resist roller 19 and pinch rollers 20 as the nip shifting means at the entry is provided in the recording paper path 5 between the paper feed roller 18 and the transfer zone of the top yellow developing station 2Y. The pair of resist roller 19 and pinch roller 20 temporarily holds the recording paper 3 supplied by the paper feed roller 18 and shifts it toward the yellow developing station 2Y in a given timely manner. While temporally held, the recording paper 3 has its leading edge oriented in parallel to the axes of the pair of resist roller 19 and pinch roller 20, preventing the recording paper 3 from being passed obliquely.

A recording paper passing detection sensor 21 is constituted by a reflection-type sensor (photoreflector), which detects the leading or tailing end of the recording paper based on the presence or absence of reflected light.

Upon the rotation of the resist roller 19 (which is turned on/off by controlling the power transmission using a not-shown electromagnetic clutch), the recording paper 3 is shifted toward the yellow developing station 2 along the recording paper path 5. Triggered by the rotation of the resist roller 19, the exposure apparatus 13Y to 13K provided near the respective developing stations 2Y to 2K are independently controlled for writing an electrostatic latent image in a timely manner.

A fixer 23 as the nip shifting means at the exit is provided in the recording paper path 5 at the downstream of the last black developing station 2K. The fixer 23 includes a heating roller 24 and a pressure roller 25. The heating roller 24 has a multilayer structure including, from the surface, an exothermic belt, a rubber roller, and a core (none of them are shown). The exothermic belt further has a three-layer structure including, from the surface, a release layer, a silicon rubber layer, and a base layer (none of them are shown). The release layer is made of fluorine resin of approximately 20 to 30 μm in thickness, providing releasing property to the heating roller 24. The silicon rubber layer is made of silicon rubber of approximately 170 μm in thickness, providing a proper elasticity against the pressure roller 25. The base layer is made of a magnetic material such as iron/nickel/chromium alloy.

A rear core 26 encloses an exciting coil. The exciting coil consisting of a given number of copper wires (not shown) insulated on the surface is extended in the rotation direction of the heating roller 24 and turned around at either end of the heating roller 24 along the periphery of the heating roller 24 in the rear core 26. When an alternate current of approximately 30 kHz is applied to the exciting coil by a semi-resonance inverter exciting circuit (not shown), a magnetic flux is created in the magnetic path formed by the rear core 26 and the base layer of the heating roller 24. The magnetic flux causes an eddy current in the base layer of the exothermic belt of the heating roller 24, whereby the base layer generates heat. The heat generated in the base layer is transmitted to the release layer via the silicon rubber layer, whereby the surface of the heating roller 24 generates heat.

A temperature sensor 27 detects the temperature of the heating roller 24. The temperature sensor 27 is a ceramic semiconductor primarily made of a metal oxide and sintered at a high temperature. The temperature sensor 27 has a load resistance changed depending on the temperature and is used to measure the temperature of an object in contact with it. The output of the temperature sensor 27 is supplied to a not-shown control unit. The control unit controls the electric power to the exciting coil in the rear core 26 based on the output of the temperature sensor 27 so that the heating roller 24 has a surface temperature of approximately 170 ° C.

When the recording paper 3 on which a toner image is formed passes through the nip part formed by the heating roller 24 having a temperature controlled as described above and the pressure roller 25, the toner image on the recording paper 3 is heated and pressurized by the heating roller 24 and pressure roller 25, whereby the toner image is fixed on the recording paper 3.

A recording paper tailing end detection sensor 28 monitors the discharge of the recording paper 3. A toner image detection sensor 32 is a reflection-type sensor unit using multiple light emitting elements having different light emission spectra (visible light) and a single light receiving element. The toner image detection sensor 32 detects the image density using differences in absorption spectrum between the background and the image parts in each image color. The toner image detection sensor 32 detects not only the image density but also the image position. Therefore, in the image forming apparatus 1 of this embodiment, the toner image detection sensor 32 is provided at two positions in the width direction of the image forming apparatus 1, whereby the timing of image forming is controlled based on the detected position of an image shift rate detection pattern.

A recording paper shift drum 33 is a metal roller of which the surface is coated with a rubber of 200 μm in thickness. The fixed recording paper 3 is shifted in the direction D2 by the recording paper shift drum 33. Meanwhile, the recording paper 3 is cooled by the recording paper shift drum 33 and curved in the direction opposite to the side on which an image is formed. In this way, the curling that tends to occur when high density images are formed on the entire recording paper is significantly reduced. Then, the recording paper 3 is shifted in the direction D6 and discharged onto a catch tray 39 by a discharge roller 35.

A face-down paper catch part 34 is rotatable about a support member 36. When the face-down paper catch part 34 is opened, the recording paper 3 is discharged in the direction D7. The face-down paper catch part 34 has ribs 37 on the back along the shift path so that when it is closed, the face-down paper catch part 34 guides the recording paper 3 in collaboration with the recording paper shift drum 33.

A drive source 38 is a stepping motor in this embodiment. The drive source 38 drives the paper feed roller 18, resist roller 19, pinch roller 20, peripheral members of the developing stations 2Y to 2K including the photosensitive bodies (8Y to 8K) and transfer rollers (16Y to 16K), fixer 23, recording paper shift drum 33, and discharge roller 35.

A controller 41 receives image data for example from a not-shown computer via external network and extends and generates printable image data.

An engine control part 42 controls hardware and mechanism of the image forming apparatus 1 to form color images on the recording paper 3 based on image data transferred from the controller 41 and takes total control over the image forming apparatus 1.

A power source 43 supplies power to the exposure apparatus 13Y to 13K, drive source 38, controller 41, and engine control part 42 and to the heating roller 24 of the fixer 23. This power source also include so-called high voltage power source systems for charging the surface of the photosensitive body 18, applying developing bias to the developing sleeve (see the reference number 10 in FIG. 2), and applying transfer bias to the transfer roller 16.

The power source 43 includes a power monitor 44, whereby at least the power voltage supplied to the engine control part 42 is monitored. Monitoring signals are detected in the engine control part 42 to detect drops in the power voltage that occur when the power switch is turned off or in case of power outage.

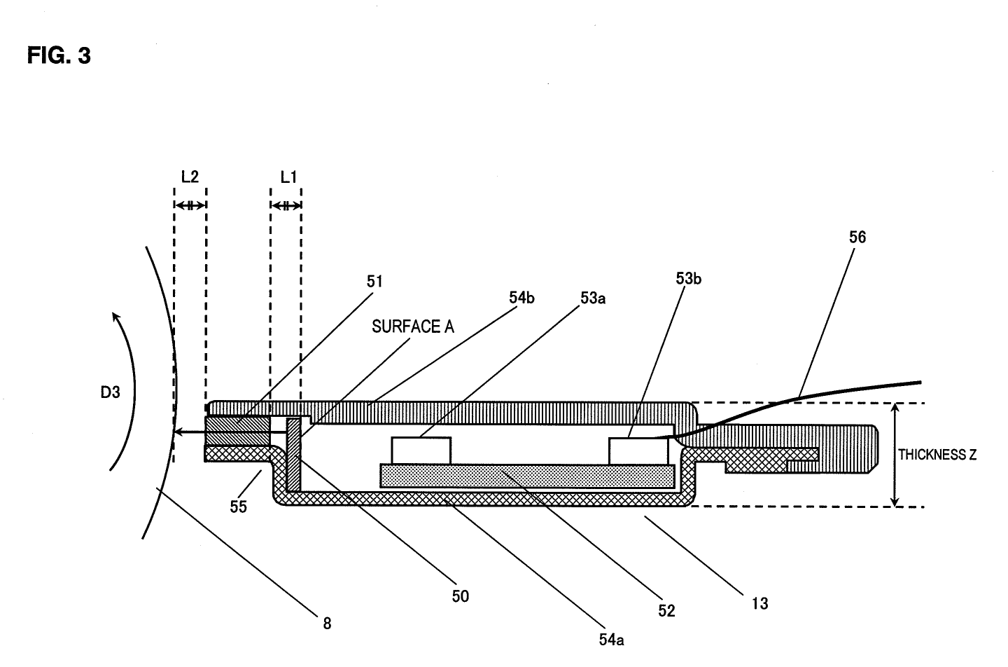

FIG. 3 is an illustration showing the structure of the exposure apparatus 13 in the image forming apparatus 1 of the first embodiment. The structure of the exposure apparatus 13 is described in detail hereafter with reference to FIG. 3. In FIG. 3, a glass substrate 50 is a colorless and transparent. Here, the glass substrate 50 is made of borosilicate glass, which advantageous in terms of cost. However, glasses containing elements for improving heat-transmission such as MgO, Al₂O₃, CaO, and ZnO or quartz can be used where heat generated in the light emitting elements or in the control circuit or drive circuit formed by a thin-film transistor on the glass substrate 50 should more effectively be released.

Organic EL elements as the light emitting elements are arranged on the surface A of the glass substrate 50 in the direction orthogonal to the sheet (the main scanning direction) at a resolution of 600 dpi (dots/inch).

The moving direction D3 of the photosensitive body 8 is the direction in which lines of images are sequentially formed by the exposure apparatus 13 in a given timely manner, namely the sub-scanning direction. As described above, it is effective to minimize the thickness Z of the exposure apparatus 13 in order to reduce the distances between the developing stations. As shown in FIG. 3, one factor to determine the thickness Z is the size of the glass substrate 50 in the sub-scanning direction. When the size of the glass substrate 50 in the sub-scanning direction is reduced, the thickness Z of the exposure apparatus 13 is possibly reduced. As described above, it is desirable that the exposure apparatus 13 has a thickness of 7 mm or smaller. Considering that the housing of the exposure apparatus 13 is required to have a wall thickness of 1 mm, the size of the glass substrate 50 in the sub-scanning direction has to be smaller than 5 mm.

A lens array 51 includes a row of rod lenses (not shown) made of plastic or glass. The lens array 51 guides the light emitted by the organic EL elements on the surface A of the glass substrate 50 to the surface of the photosensitive body 8 as an upright image of the same size. The glass substrate 50, lens array 51, and photosensitive body 80 are positioned so that the lens array 51 has one focal point on the surface A of the glass substrate 50 and the other on the surface of the photosensitive body 8. In other words, assuming L1 is the distance between the surface A and the one surface of the lens array 51 that is closer to the surface A and L2 is the distance between the other surface of the lens array 51 and the photosensitive body 8, L1=L2.

A relay substrate 52 is for example a glass epoxy substrate. At least a connector A 53a and a connector B 53b are mounted on the relay substrate 52. The relay substrate 52 relays image data, light amount correction data, and other control signals supplied to the exposure apparatus 13 from an external source via a cable 56 such as a flexible flat cable, and then supplies these signals to the glass substrate 50.

It is difficult to mount connectors directly on the surface of the glass surface 50 in consideration of connection strength and reliability in various environments. Then, the connector A 53a of the relay substrate 52 is connected to the glass substrate 50 via an FPC (flexible print circuit, which is not shown, but described in detail later). The connection between the substrate 50 and the FPC is made by directly connecting the FPC to for example an ITO (tin-doped indium oxide) electrode previously formed on the glass substrate 50 for example using an ACF (anisotropic conductive film).

On the other hand, the connector B 53b is a connector to connect the exposure apparatus 13 to the external. Generally, connections including ACF connection have problems with connection strength. However, with the connector B 53b being provided on the relay substrate for the user to connect the exposure apparatus 13, the interface to which the user directly access is ensured in strength.

A housing A 54a is formed by bending and shaping a metal plate. The hosing A 54a has an L-shaped part 55 on the side facing the photosensitive body 8. The glass substrate 50 and lens array 51 are provided along the L-shaped part 55. The end of the housing A 54a on the photosensitive body 8 side and the end of the lens array 51 is aligned and the housing A 54a supports the glass substrate 50 at one end. With the L-shaped part 55 being shaped with accuracy, the positional relationship between the glass substrate 50 and the lens array 51 can be determined with accuracy. Since the housing A 54a is required to have dimensional accuracy, it is desirably made of a metal. When the housing A 54a is made of a metal, the influence of noise on control circuits formed on the glass substrate 50 and electronic parts such as IC chips mounted on the surface of the glass substrate 50 can be controlled. The glass substrate 50 is supported on the surface opposite to the surface A thereof, whereby the surface A where the organic EL elements are formed does not need to have a part to support the glass substrate 50. Furthermore, only a space for guiding the light from the organic EL elements to the lens array 51 is necessary on the surface opposite to the surface A, ensuring a relatively large mounting and supporting area. Then, the glass substrate 50 can securely be supported while having a small width.

The housing B 54b is formed by shaping a resin. The housing B 54b has a notch (not shown) near the connector B 53b. The user can access to the connector B 53b through the notch. Image data, light amount correction data, control signals such as clock signals and line synchronizing signals, drive power source of the control circuit, and drive power source of the organic EL elements or light emitting elements are supplied to the exposure apparatus 13 from outside the exposure apparatus 13 via the cable 56 connected to the connector B 53b.

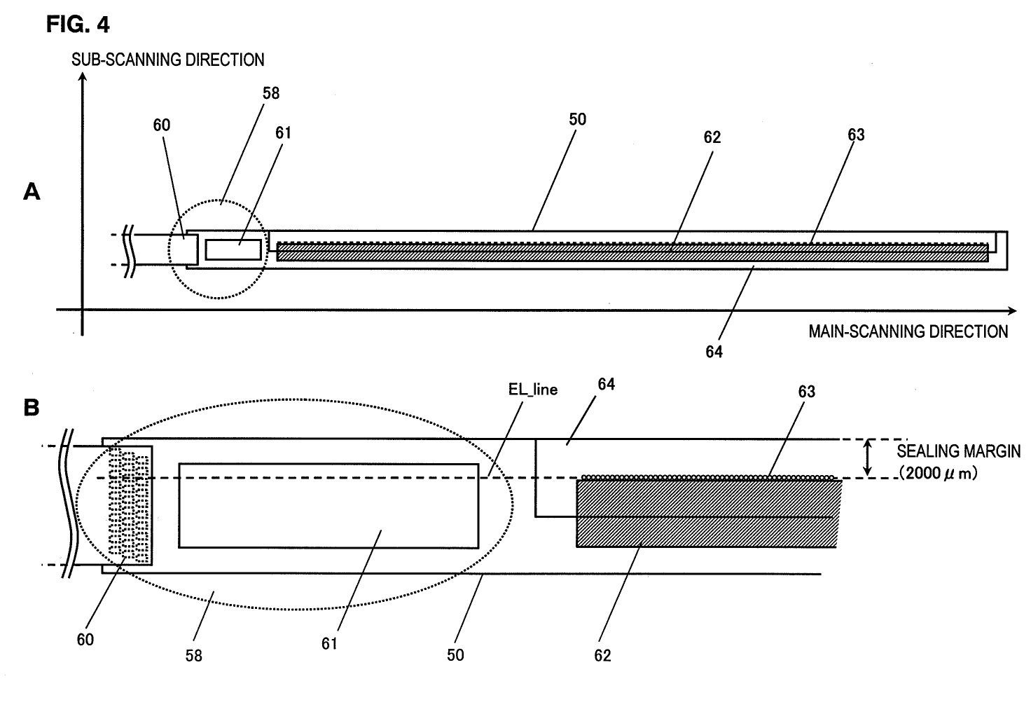

FIG. 4A is a top view of the glass substrate 50 of the exposure apparatus 13 in the image forming apparatus 1 of the first embodiment and FIG. 4B is an enlarged view of the core part of the same. The structure of the glass substrate 50 of the first embodiment is described in detail hereafter with reference to FIG. 4 along with FIG. 3.

In FIG. 4, the glass substrate 50 has a thickness of approximately 0.7 mm and is in the form of a rectangular at least having a length and a width. Multiple organic EL elements 63 or light emitting elements are arranged in the longitudinal direction (the main scanning direction). In this embodiment, light emitting elements necessary for exposing at least the size A4 (210 mm) are arranged in the longitudinal direction of the glass substrate 50. The glass substrate 50 has a length of 250 mm including the space for a drive control unit 58 described later. Here, the glass substrate 50 is rectangular for simplified explanation. However, the glass substrate 50 can be of a modified form for example having positioning notches used in installing the glass substrate 50 in the housing A 54a.

The drive control unit 58 receives control signals (signals for driving the organic EL elements 63 as the light emitting elements) supplied from outside the glass substrate 50 and controls the drive of the organic EL elements 63 based on the control signals. The drive control unit 58 includes an interface unit for receiving control signals from outside the glass substrate 50 as described later and an IC chip (source driver) for controlling the drive of the light emitting elements based on the control signals received via the interface unit.

An FPC (flexible print circuit) 60 is an interface unit configured to connect the connector A 53a of the relay substrate 52 to the glass substrate 50. The FPC 60 is directly connected to a not-shown circuit pattern on the glass substrate via no connector. As described above, image data, light amount correction data, control signals such as clock signals and line synchronizing signals, drive power source of the control circuit, and drive power source of the organic EL elements 63 or light emitting elements, which are supplied from outside the exposure apparatus 13, are once relayed by the relay substrate 52 shown in FIG. 3 and then supplied to the glass substrate 50 via the FPC 60.

The organic EL elements 63 are the light source of the exposure apparatus 13. In this embodiment, a total of 5,120 organic EL elements 63 are linearly arranged in the main scanning direction at a resolution of 600 dpi. The individual organic EL elements 63 are independently turned on/off by TFT circuits described later.

A source driver 61 is an IC chip for controlling the drive of the organic EL elements 63 and flip-chip mounted on the glass substrate 50. The source driver 61 is a bare-chip in consideration of surface mounting on the glass surface. Control-related signals such as power source, clock signals, and line synchronizing signals and light amount correction data (for example 8-bit multi-value data) are supplied to the source driver 61 from outside the exposure apparatus 13 via the FPC 60. The source driver 61 is a drive parameter setting unit for the organic EL elements 63 as described in detail later. More specifically, the source driver 61 sets a drive current value for each organic EL element 63 based on light amount correction data supplied via the FPC 60.

The connection part of the FPC 60 is connected to the source driver 61 on the glass substrate 50 for example via an ITO circuit pattern (not shown) on the surface of which metal is formed. The source driver 61 as the drive parameter setting unit receives light amount correction data and control signals such as clock signals and line synchronizing signals via the FPC 60. The FPC 60 as the interface unit and the source driver 61 as the drive parameter setting unit constitute the drive control unit 58.

A TFT (thin-film transistor) circuit 62 is formed on the glass substrate 50. The TFT circuit 62 includes a gate controller for controlling the turn-on/turn-off of the light emitting elements such as a shift transistor and data latch and drive circuits (termed the pixel circuits hereafter) for supplying a drive current to the individual organic EL elements 63. The pixel circuits are provided one each for the organic EL elements 63 and arranged in parallel to the row of light emitting elements formed by the organic EL elements 63. As described later, the source driver 61 as the drive parameter setting unit sets in the pixel circuit a drive current value for driving the individual organic EL element 63.

Control signals such as power source, clock signals, and line synchronizing signals and image data (1-bit binary data) are supplied to the TFT circuit 62 from outside the exposure apparatus 13 via the FPC 60. The TFT circuit 62 turns on/off the individual light emitting elements based on these power source and signals.

A sealing glass 64 is necessary for blocking moisture because the organic EL elements 63 may shrink or form dark spots in the light emitting area over time under influence of moisture, having deteriorated light emitting property. In the first embodiment, the solid sealing is used in which the sealing glass 64 is attached to the glass substrate 50 using an adhesive. The sealing zone is generally considered to be approximately 2,000 μm in the sub-scanning direction from the row of light emitting elements constituted by the organic EL elements 63. In the first embodiment, the sealing margin of 2,000 μm is reserved.

In the first embodiment, the FPC 60 as the interface unit and the source driver 61 as the drive parameter setting unit, which together constitutes the drive control unit 58, are placed on the extended line (EL_line) of the row of light emitting elements formed by the organic EL elements 63.

With this arrangement, the drive control unit 58 is placed at any point in the long side direction of the glass substrate 50 (the main scanning direction) where it does not overlap with the row of light emitting elements. The row of light emitting elements and drive control unit 58 are not arranged in the short side direction of the glass substrate 50 (the sub-scanning direction). Furthermore, with this arrangement, the drive control unit 58 is placed at any point in the long side direction of the glass substrate 50 (the main scanning direction) where it does not overlap with the TFT circuit 62 (including the pixel circuits) placed in parallel to the row of light emitting elements, either.

In other words, the drive control unit 58 is placed at the end of the glass substrate 50 in the longitudinal direction (the main scanning direction). In the first embodiment as shown in the figure, the FPC 60 as the interface unit, source driver 61, and row of organic EL elements 63 are linearly arranged in the longitudinal direction of the substrate 50 (the main scanning direction). The FPC 60 is placed at the farthest point in the longitudinal direction of the substrate 50 to effectively use the space on the glass substrate 50. Here, the connection terminals of the FPC 60 are desirably arranged in multiple rows of staggered pattern, not in a linear pattern in the width direction (the sub-scanning direction). In this way, even if the glass substrate has a small width, a necessary number of terminals for driving the exposure apparatus can be ensured.

With the drive control unit 58 being properly positioned on the glass substrate 50, the glass substrate 50 is allowed to be significantly reduced in size in the short side direction compared to the structures in which multiple IC chips are arranged in parallel to the row of light emitting elements or an external interface unit configured to supply signals to the IC chips is placed at the farthest point in the short side direction of the substrate.

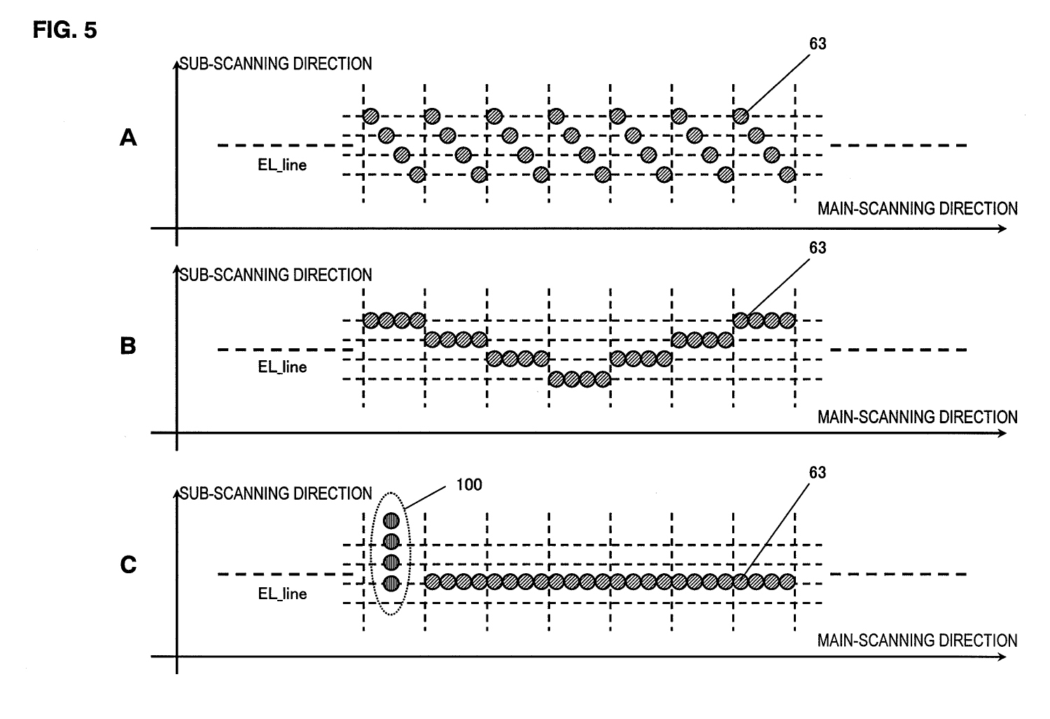

FIG. 5 is an illustration showing the geometry of organic EL elements 63 on the glass substrate 50 in the image forming apparatus of the first embodiment. As described above, in this embodiment, the organic EL elements 63 form a row of light emitting elements. The drive control unit 58 is placed on the extended line (EL_line) of the row of light emitting elements. For example, when the organic EL elements 63 are arranged in a staggered pattern as shown in FIG. 5A or in a staircase pattern as shown in FIG. 5B, the EL_line means an extended line having a width in the sub-scanning direction depending on the geometry of the light emitting elements in the sub-scanning direction. The drive control unit 58 shown in FIG. 4 is at least partly placed on the extended line having such a width.

Furthermore, as shown in FIG. 5C, when dummy elements 100 that are used for tests and do not emit light upon regular exposure are arranged in the sub-scanning direction at the start point or at the end point of the row of light emitting elements formed by the organic EL elements, the EL_line means the extended line of the row of light emitting elements that actually achieve the exposure. The drive control unit 58 shown in FIG. 4 is at least partly placed on this extended line. In such a case, the extended line may have a width equal to the dummy elements 100 in the sub-scanning direction.

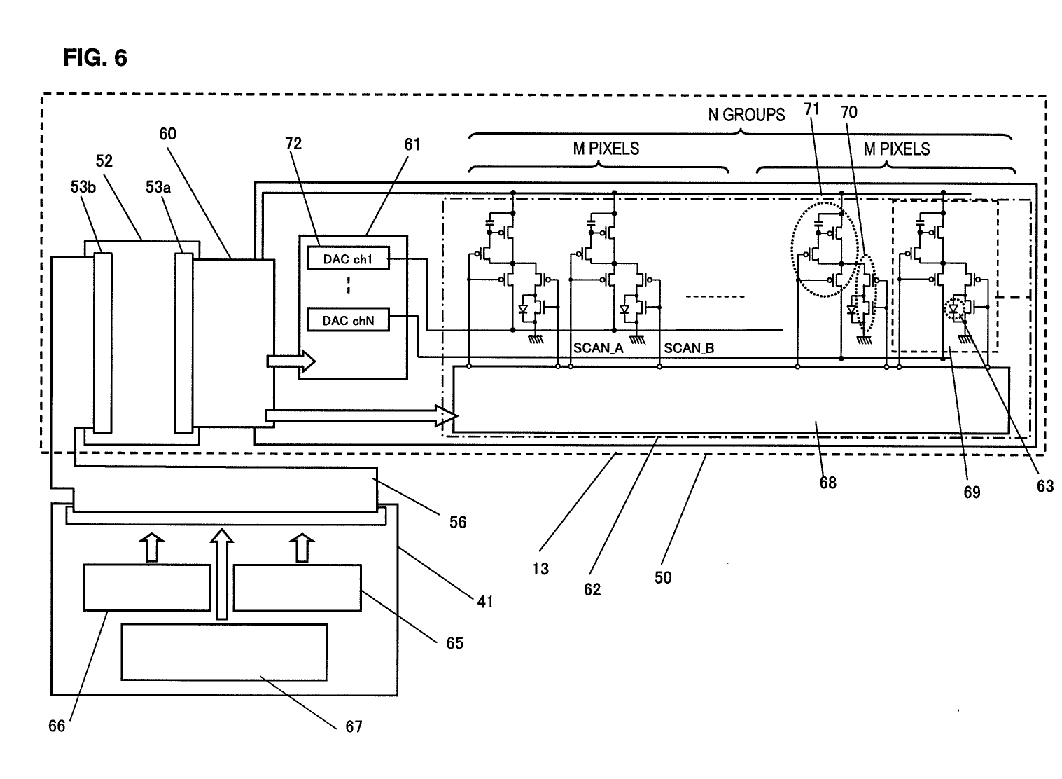

FIG. 6 is a circuit diagram of the exposure apparatus 13 in the image forming apparatus 1 of the first embodiment. The turn-on control by the TFT circuit 62 and source driver 61 and the size in the sub-scanning direction of the glass substrate 50 are described in detail hereafter with reference to FIG. 6.

In FIG. 6, a controller 41 is the one described with reference to FIG. 1, receiving image data from a not-shown computer and generating printable image data. An image memory 65 stores binary image data generated by the controller 41 based on commands transferred from the not-shown computer. A light amount correction data memory 66 stores light amount correction data. The light amount correction data memory 66 is a nonvolatile memory such as a ROM. The production process of the exposure apparatus 13 includes a step of measuring the luminance or luminance distribution of all organic EL elements and calculating the light amount correction data for equalizing the luminance of all organic EL elements 63 based on the measurements for each exposure apparatus 13. The light amount correction data memory 66 stores such light amount correction data values.

A timing part 67 generates control signals relating to the timing of driving the exposure apparatus 13. Image data stored in the image memory 65 and light amount correction data stored in the light amount correction data memory 66 are supplied through the end of the glass substrate 50 via the cable 56, connector B 53b, relay substrate 52, connector A 53a, and FPC 60 based on signals generated by the timing part 67, such as clock signals and line synchronizing signals.

The image data and timing signals supplied to the glass substrate 50 are supplied to the TFT circuit 62 via a wiring formed on the glass substrate 50 for example by an ITO with a metal layer thereon. The light amount correction data and timing signals are supplied to the source driver 61.

The TFT circuit 62 largely includes pixel circuits 69 and a gate controller 68. The pixel circuits 69 are provided one each for the individual organic EL elements 63. N groups of M pixels of organic EL elements 63 are provided on the glass substrate 50. In this embodiment, one group consists of eight pixels (M=8) and there are 640 groups. Accordingly, a total of 8×640=5,120 pixels are provided. The pixel circuits 69 each comprise a driver part 70 for supplying a current to the organic EL element 63 and driving it, and a so-called current program part 71 for storing in an internal capacitor a current value (the drive current value for the organic EL element 63) supplied by the driver for turning on the organic EL element 63. The organic EL element 63 can be driven by a constant current according to the drive current value previously programmed in a given timely manner.

The gate controller 68 comprises a shift register that sequentially shifts input binary image data, a latch part provided in parallel to the shift register and storing a given number of pixels at a time after they are supplied to the shift register, and a control part controlling these operation timings (none of them are shown). The gate controller 68 outputs signals SCAN_A and SCAN_B shown in FIG. 6, thereby controlling the turn-on/turn-off of the organic EL elements 63 connected to the pixel circuits 69 and the timing of the current program time for setting the drive current.

On the other hand, the source driver 61 contains a corresponding number of D/A converters 72 (which is described later) to the group number N (640 in this embodiment) of the organic EL elements 63. The source driver 61 equalizes the luminance of the organic EL elements 63 by setting a drive current for each organic EL element 63 based on the light amount correction data (for example 8 bits) supplied via the FPC 60. As described above, 5,120 organic EL elements 63 are necessary for obtaining an exposure range for the size A4 (approximately 210 mm) at a resolution of 600 bpi in the main scanning direction. The inventors of the present invention estimated that the TFT circuit 62 requires approximately 500,000 gates for driving these pixels. Assuming that a 4.5 μm process rule is applied, the shift register, latch part, and other control circuits in the gate controller 68 have a width of approximately 1,000 μm and the pixel circuits 69 have a width of 200 μm. These lengths are necessary in the sub-scanning direction. The wiring from the source driver 61 to the pixel circuits 69 can be as short as 1,500 μm using a multilayer structure wiring. In total, the TFT circuit has to have a width of approximately 2,700 μm in the sub-scanning direction. Here, as described with reference to FIG. 4, the sealing margin of the sealing glass 64 requires approximately 2,000 μm. Therefore, the glass substrate 50 has a width of approximately 2,700+2,000=4,700 μm in the sub-scanning direction.

On the other hand, the width of the source driver 61 in the sub-scanning direction can be as small as 3,000 μm when 640 D/A converters 72 are mounted (the length in the main scanning direction is approximately 16,000 μm). As described above, the source driver 61 is mounted at a position on the extended line of the row of light emitting elements on the glass substrate 50. Then, the width of the source driver 61 is not a factor to determine the size of the glass substrate 50 in the sub-scanning direction. The row of light emitting elements and rectangular source driver 61 are linearly arranged in the long side direction of the glass substrate, whereby the glass substrate is minimized in size in the sub-scanning direction.

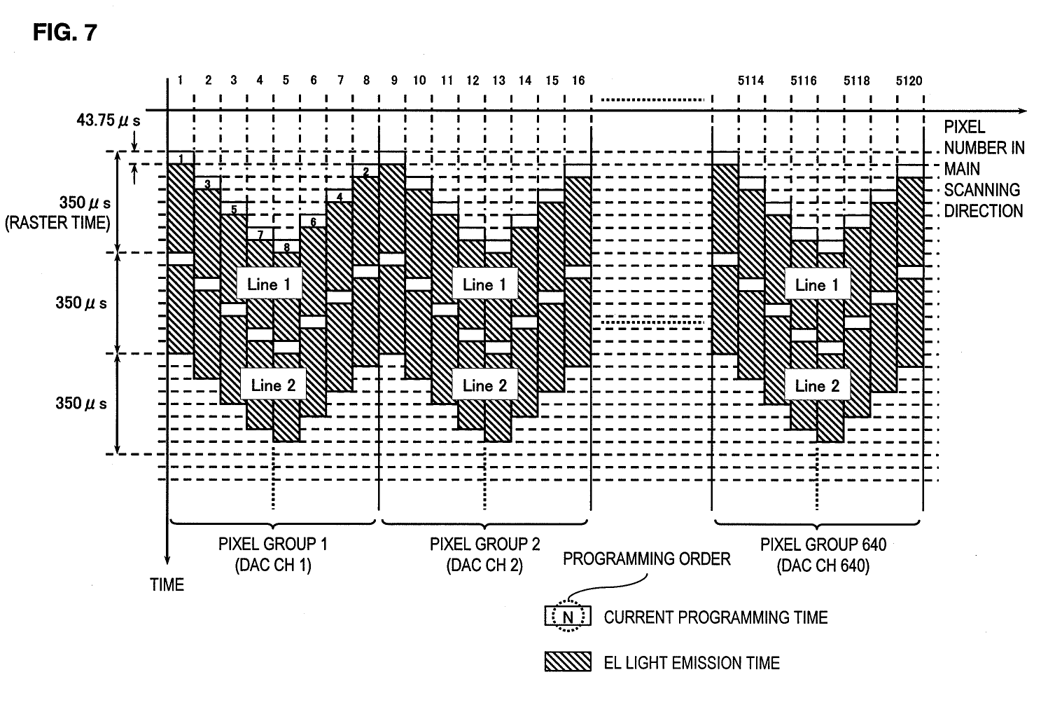

FIG. 7 is an illustration for explaining the current program time and the turn-on time of the organic EL elements 63 of the exposure apparatus 13 in the mage forming apparatus 1 of the first embodiment. The turn-on control of the first embodiment is described in detail hereafter with reference to FIG. 7 along with FIG. 6. For simplified explanation, a single group of 8 pixels is described hereafter.

The exposure apparatus 13 of this embodiment has a line time (raster time) of 350 μs. One eighth (43.77 μs) of the one line time corresponds to the program time for setting a drive current value in the capacitor formed in the current program part 71.

First, the gate controller 68 sets the signal SCAN_A for ON and the signal SCAN_B for OFF to establish the program time for a pixel having a pixel number=1. During the program time, the D/A converter 72 receives light amount correction data (for example 8 bits). Analog level signals obtained by converting the supplied digital data are used to charge the capacitor of the current program part 71.

After the program time ends, the gate controller 68 immediately sets the signal SCAN_A for OFF and the signal SCAN_B for ON to establish the turn-on time. Because binary image data are supplied to the gate controller 68, the organic EL element 63 is not turned on even during the turn-on time if image data are OFF. On the other hand, if image data are ON, the organic EL element 63 is turned on in the remaining time or 306.25 μs (350 μs-43.75 μs) (this is given for simplified explanation although the control signals switching time is present and the light emission time is slightly shorter in practice).

After the program time of the pixel circuit 69 having a pixel number=1 ends, the gate controller 68 immediately establishes the current program time of the pixel circuit 69 having a pixel number=8. Then, the turn-on time of the organic EL element 63 having a pixel number=8 follows immediately after the program time of the pixel circuit of this pixel number ends in the same process as for the pixel circuit having a pixel number=1.

In this way, the gate controller 68 establishes the program time and the turn-on time of the pixel numbers=“1→8→2→7→3→6→4→5→1 . . . ” in sequence. In this turn-on order, the turn-on times of the closest pixels in adjacent pixel groups are close to each other. Therefore, unevenness in image between pixel groups in forming a line of image on the photosensitive body rotating in the sub-scanning direction using light emitting elements arranged in the main scanning direction can be less visible. If the program time and turn-time are established in the order of the pixel numbers=“1→2→3→4→5→6→7→8→1 . . . ,” the unevenness corresponding to the rotation rate of the photosensitive body in the seven program times appears between adjacent pixel groups.

The value set in the pixel circuit 69 during the current program time is for example 8-bit light amount correction data as described above. The organic EL elements 63 are formed by a coating process such as spin coating. Therefore, the correlation between adjacent pixels is extremely high. With this effect, the organic EL elements 63 in the vicinity of a given organic EL element 63 have nearly the same luminance. The correlation of light amount correction data for the organic EL elements in the vicinity is also extremely high. Then, light amount correction data for the pixel number=1 and light amount correction data for the pixel number=8 are not significantly different.

During the current program time controlled by the gate controller 68, a current value corresponding to the light amount correction data is supplied to the pixels circuit 69 to charge the capacitor in the pixel circuit 69 by a so-called constant current source. The time required for the charging is expressed by the following equation (Math 1).

[Math 1]

t=C*V/i

where C is a capacitance, V is a potential difference, and i is a provided current.

According to the equation (Math 1), the charging time is proportional to the capacitance. If the capacitance C is increased as a result of increased line capacitance due to extended wiring, the charging time is accordingly increased. In this embodiment, the source driver is placed on the extended line of the row of light emitting elements. Even though the source driver is placed near the row of light emitting elements on the glass substrate 50, the delayed charging due to line capacitance is generally concerned in the pixel group farthest from the source driver 61.

However, in the first embodiment, the source driver 61 is used to supply light amount correction data. As described above, light amount correction data are highly possibly of the same value in a single pixel group. Then, the V in the equation (Math 1) is nearly unchanged in each pixel group. Consequently, though the charging time depends on differences in the V between the pixel numbers sequentially selected in the current program time, differences in the V between the pixel numbers selected are significantly small from the beginning, whereby the charging time is significantly small. Therefore, in this embodiment, there is almost no problem with the time shortage in the current program time due to extended wiring from the source driver 61. As described above, the distance between the source driver 61 and the pixel circuits 69 on the glass substrate can be large.

The above circumstances are significantly different from the displays in which a drive current is determined for each pixel using the current program technique and multiple tones such as 64 or 256 tones are reproduced in each pixel. The voltage is reset in each program for realizing the multiple tones in each pixel. On the other hand, in the above described structure, the voltage does not need to be reset for the pixels in a pixel group. This is a merit unique to the exposure apparatus 13 in which the tune-on/turn-off is controlled based on binary image data and the drive current is set by the current program technique based on multi-value light amount correction data.

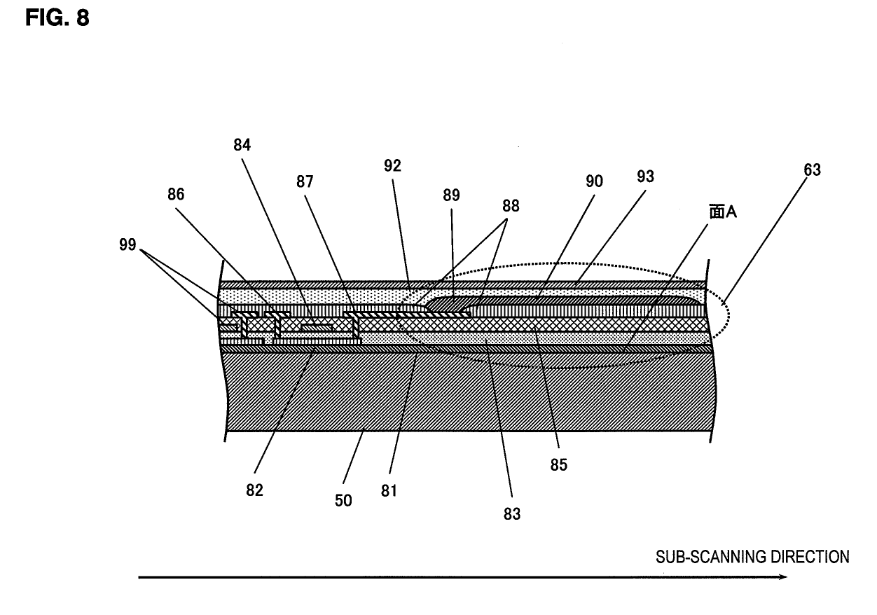

FIG. 8 is a cross-sectional view of the organic EL element 63 of the exposure apparatus 13 in the image forming apparatus 1 of the first embodiment. The structure of the organic EL element in this embodiment is described in detail hereafter with reference to FIG. 8.

In FIG. 8, a base coating layer 81 is formed on the surface A (corresponding to the surface A in FIG. 3) of the glass surface 50 for example by depositing SiN and SiO₂. A TFT 82 of polycrystalline silicon (polysilicon) is formed on the base coating layer 81. In the first embodiment, the TFT 82 is made of polycrystalline silicon. However, it can be made of amorphous silicon. Amorphous silicon is disadvantages in design rules and drive frequencies over polycrystalline silicon. However, inexpensive production process leads to a merit in cost.

A gate insulating layer 83 is for example made of SiO₂ and separates and insulates the TFT 82 from a gate electrode 84 made of a metal such as Mo. An intermediate layer 85 is formed for example by depositing SiO₂ and SiN. The intermediate layer 85 covers the gate electrode 84 and supports a source electrode 86 and a drain electrode 87 formed by a metal such as Al along the surface. The source electrode 86 and drain electrode 87 are connected to the TFT 82 via contact holes formed in the intermediate layer 85 and gate insulating layer 83. A given potential is applied to the gate electrode 84 while a give potential is applied between the source electrode 86 and the drain electrode 87, whereby the TFT 82 serves as a switching transistor.

A protective layer 88 is formed for example by SiN. The protective layer 88 completely covers the source electrode 86 and forms a contact hole 89 in part of the drain electrode 87. A transparent electrode (hole injection electrode) 90 is formed on the protective layer 88 and made of ITO (tin-doped indium oxide) in this embodiment. The transparent electrode 90 can be made of IZO (zinc-doped indium oxide), ZnO, SnO₂, or In₂O₃ besides ITO. The transparent electrode 90 can be formed by vapor deposition. However, it is desirable that the transparent electrode 90 is formed by sputtering. The transparent electrode 90 is connected to the drain electrode 87 via the contact hole 89.

An organic EL layer 92 is formed on the same surface as the TFT 82 is formed for example by spin coating or vapor deposition. Here, a hole injection layer can be formed between the transparent electrode 90 and the organic EL layer 92 for example by metal oxide. A negative electrode 93 is formed by vapor deposition of a metal such as Al. Here, an electron injection layer is desirably formed between the organic EL layer 92 and the negative electrode 93 for example by a single metal element such as K, Li, Na, Mg, La, Ce, Ca, Sr, Ba, Al, Ag, Ln. Sn, Zn, and Zr, by their binary or ternary alloy for improved stability, or by depositing single metal elements such as Ca and Al in this order from the organic EL layer 92. The organic EL material can be a low molecular weight material or a high molecular weight material.

The organic EL elements 63 are formed on the glass substrate 50 in the above described structure and process. The TFT 82 is formed on a one-on-one basis in relation to the organic EL elements 63 and forms an electrically so-called active matrix circuit. The source electrode 86 of each organic EL element 63 serves as the positive electrode. A given potential is applied between the source electrode 86 and the negative electrode 93 and a given potential is applied to the gate electrode 84, whereby a current flows through the source electrode 86, TFT 82, drain electrode 87, transparent electrode 90, organic EL layer 92, and negative electrode 93. Then, the organic EL layer 92 in the area between the transparent electrode 90 and negative electrode 93 emits light. The light emitted from the organic EL layer 92 is transmitted through the transparent electrode 90, intermediate layer 85, gate insulating layer 83, base coating layer 81, and glass substrate 50, exiting from the surface opposite to the surface A and exposing a not-shown photosensitive body. The structure in which light is retrieved from the opposite surface of the substrate to the surface A on which the organic EL layer 92 is formed (the bottom emission) facilitates the sealing of the organic EL layer 92. The number 99 represents a wiring pattern. For example, light amount correction data analog signals output from the source driver 61 shown in FIG. 6 are connected to the pixel circuit 69 using the wiring pattern 99 provided on the intermediate layer 85.

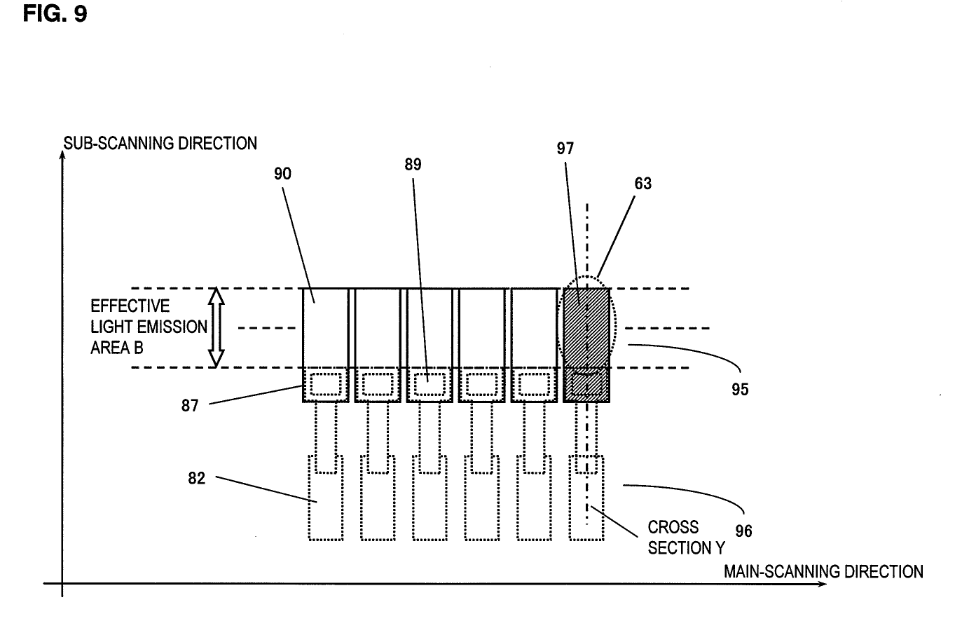

FIG. 9 is a top view of the organic EL element 63 of the exposure apparatus 13 in the image forming apparatus 1 of the first embodiment. The geometry of the organic EL element 63 and TFT 82 (drive circuit) of the exposure apparatus 13 in this embodiment is described in detail hereafter with reference to FIG. 9.

The cross-section Y in FIG. 9 corresponds to the cross-sectional view of FIG. 8.

In FIG. 9, the organic EL layer 92 and negative electrode 93 in FIG. 8 are eliminated to show the transparent electrode 90. The TFT 82 and drain electrode 87 are indicated by dotted lines. This means that the TFT 82 and drain electrode 87 are covered with the transparent electrode 90 or protective layer 88.

In this embodiment, the organic EL elements 63 are provided at pitches of 600 dpi in the main scanning direction. Then, the organic EL elements 63 are provided at pitches of 42.3 μm. The distance between adjacent organic EL elements 63 at pitches of 42.3 μm is 7 μm. When the transparent electrodes 90 are formed using an exposure pattern with intervals of 5 μm, the edge portion of the remaining pattern (the transparent electrode in this case) shrinks by approximately 1 μm in the positive process in which the exposed area is removed; therefore, the transparent electrodes 90 are formed at intervals of 7 μm. Considering the shrinkage of the pattern in the process, the transparent electrode 90 of a desired size can be obtained. In this way, the organic EL elements 93 constitute a light emitting element set 95 in this embodiment.

The individual transparent electrodes 90 are formed for example by Al on the back and connected to the drain electrodes 87 formed on a one-on-one basis in relation to the transparent electrodes 90. The drain electrodes 87 are further connected to the TFTs 82, which is actually not seen because of the protective layer 99. As also shown in FIG. 8, the drain electrode 87 is extended from the TFT 82 by a given length in the sub-scanning direction and connected to the transparent electrode 90 at the end via the contact hole 89. The same structure is formed in the main scanning direction for all organic EL elements (5,120 structures), whereby the TFTs 82 constitute a TFT set 96 in the main scanning direction.

The light emitting element set 95 and TFT set 96 are completely separated on the surface of the glass substrate 50 in the sub-scanning direction. The transparent electrodes 90 included in the light emitting element set 95 and the TFTs 82 included in the TFT set 96 are connected by the metal drain electrodes 87. In this way, the light emitting element set 95 and the TFT set 96 are spatially completely separated, whereby the TFT set 96 can be formed in an extended area in the sub-scanning direction.

In this embodiment, the exposure apparatus 13 has a resolution of 600 dpi. The light emitting element set 95 and TFT set 96 are completely separated as described above. Therefore, the TFT zone can be extended in the sub-scanning direction, whereby the exposure apparatus 13 having a high resolution of 1,200 dpi or 2,400 dpi in the main scanning direction can easily be obtained while ensuring a required effective light emission zone B. When the TFT 82 constituting the active matrix circuit is increased in size for controlling the emitted light amount with high accuracy, or when a larger drive current is required for increased luminance, in other words, when the transistor is increased in size, the space for the TFT 82 in the sub-scanning direction can be ensured.

### SECOND EMBODIMENT

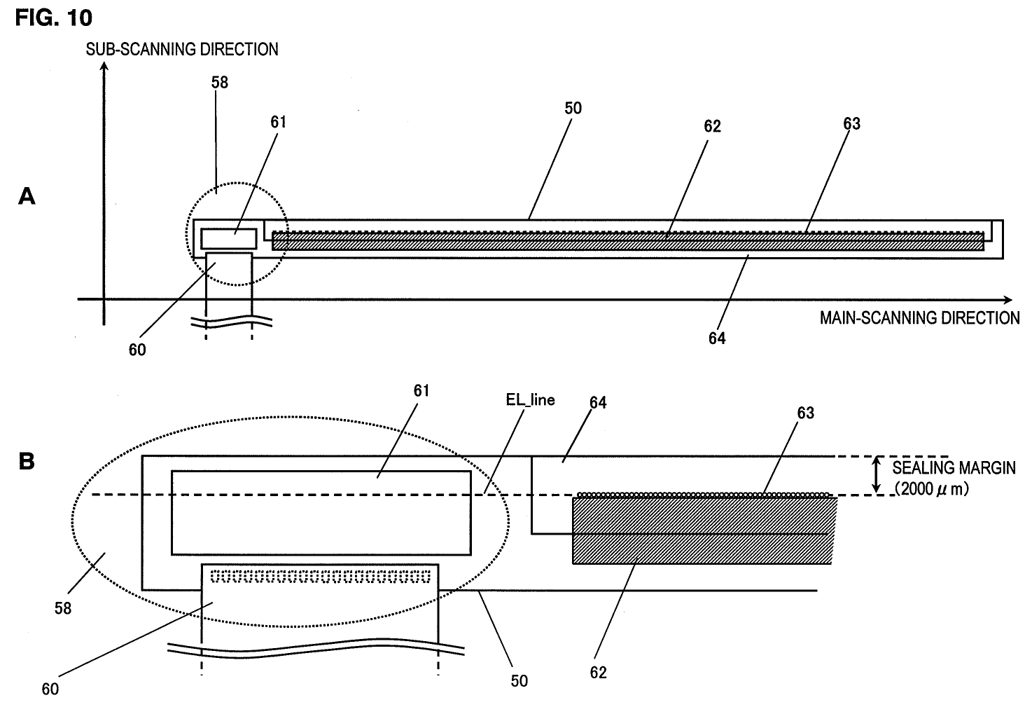

FIG. 10A is a top view of the glass substrate 50 of the exposure apparatus 13 in the image forming apparatus 1 of the second embodiment and FIG. 10B is an enlarged view of the core part of the same. The structure of the glass substrate 50 of the second embodiment is described in detail hereafter with reference to FIG. 10 along with FIG. 3. The entire structure of the image forming apparatus 1 and structure of the exposure apparatus are already described above and their explanation is omitted here.

In FIG. 10, the glass substrate 50 has a thickness of approximately 0.7 mm and is in the form of a rectangular at least having a long side and a short side. Multiple organic EL elements 63 or light emitting elements are linearly arranged in the long side direction of the glass substrate 50 (the main scanning direction). In the first embodiment, a necessary number of light emitting elements for exposing the size A4 (210 mm) are arranged in the longitudinal direction of the glass substrate 50 and the glass substrate 50 has a length of 250 mm including the space for providing the drive control unit 58 described later. Here, the glass substrate 50 in the form of a rectangular as in the first embodiment is described. However, the glass substrate 50 can be of a modified form for example having positioning notches used in installing the glass substrate 50 in the housing A 54a.

The drive control unit 58 receives control signals (signals for driving the organic EL elements 63 as the light emitting elements) supplied from outside the glass substrate 50 and controls the drive of the organic EL elements 63 based on the control signals. The drive control unit 58 includes an interface unit for receiving control signals from outside the glass substrate 50 as described later and an IC chip (source driver) for controlling the drive of the light emitting elements based on the control signals received via the interface unit.

An FPC (flexible print circuit) 60 is an interface unit for connecting the connector A 53a of the relay substrate 52 to the glass substrate 50. The FPC 60 is directly connected to a not-shown circuit pattern on the glass substrate via no connector. Image data, light amount correction data, control signals such as clock signals and line synchronizing signals, drive power source of the control circuit, and drive power source of the organic EL elements 63 or light emitting elements, which are supplied from outside the exposure apparatus 13, are once relayed by the relay substrate 52 shown in FIG. 3 and then supplied to the glass substrate 50 via the FPC 60.

In the second embodiment, the FPC 60 is provided at the end of the glass substrate 50 in the short side direction (the sub-scanning direction).

The organic EL elements 63 are the light source of the exposure apparatus 13. In this embodiment, a total of 5,120 organic EL elements 63 are linearly arranged in the main scanning direction at a resolution of 600 dpi. The individual organic EL elements 63 are independently turned on/off by TFT circuits described later.

A source driver 61 is an IC chip configured to control the drive of the organic EL elements 63 and flip-chip mounted on the glass substrate 50. The source driver is a bare-chip in consideration of surface mounting on the glass surface. Control-related signals such as power source, clock signals, and line synchronizing signals and light amount correction data (for example 8-bit multi-value data) are supplied to the source driver 61 from outside the exposure apparatus 13 via the FPC 60. The source driver 61 is a drive parameter setting unit for the organic EL elements 63. More specifically, the source driver 61 sets a drive current value for each organic EL element 63 based on light amount correction data supplied via the FPC 60.

The connection part of the FPC 60 is connected to the source driver 61 on the glass substrate 50 for example via an ITO circuit pattern (not shown) on the surface of which metal is formed. The source driver 61 as the drive parameter setting unit receives light amount correction data and control signals such as clock signals and line synchronizing signals via the FPC 60. The FPC 60 as the interface unit and the source driver 61 as the drive parameter setting unit constitute the drive control unit 58.

A TFT (thin-film transistor) circuit 62 is formed on the glass substrate 50. The TFT circuit 62 includes a gate controller for controlling the turn-on/turn-off of the light emitting elements such as a shift transistor and data latch and drive circuits (termed the pixel circuits hereafter) for supplying a drive current to the individual organic EL elements 63. The pixel circuits are provided one each for the organic EL elements 63 and arranged in parallel to the row of light emitting elements formed by the organic EL elements 63. As described in the first embodiment, the source driver 61 as the drive parameter setting unit sets in the pixel circuit a drive current value for driving the individual organic EL element 63.

Control signals such as power source, clock signals, and line synchronizing signals and image data (1-bit binary data) are supplied to the TFT circuit 62 from outside the exposure apparatus 13 via the FPC 60. The TFT circuit 62 turns on/off the individual light emitting elements based on these power source and signals.

Sealing is necessary for blocking moisture because the organic EL elements 63 may shrink or form dark spots in the light emitting area over time under influence of moisture, having deteriorated light emitting property. In the second embodiment, the solid sealing is used in which a sealing glass 64 is attached to the glass substrate 50 using an adhesive. The sealing zone is generally considered to be approximately 2,000 μm in the sub-scanning direction from the row of light emitting elements constituted by the organic EL elements 63. In the second embodiment, the sealing margin of 2,000 μm is reserved.

In the second embodiment, among the FPC 60 as the interface unit and the source driver 61 as the drive parameter setting unit, which together constitutes the drive control unit 58, the source driver 61 is placed on the extended line (EL_line) of the row of light emitting elements formed by the organic EL elements 63 and the drive control unit 58 is placed at any point in the longitudinal direction of the glass substrate 50 (the main scanning direction) where it does not overlap with the row of light emitting elements or TFT circuit 62 (including the pixel circuits).

In other words, the drive control unit 58 is placed at the end of the glass substrate 50 in the long side direction (the main scanning direction). Furthermore, in the second embodiment as shown in the figure, the FPC 60 as the interface unit is placed at the farthest point in the short side direction of the row of light emitting elements and glass substrate 50 (sub-scanning direction) to effectively use the space on the glass substrate 50. The FPC 60 is placed at the farthest point in the width direction of the substrate 50 (sub-scanning direction), whereby the space to provide connection terminals is less limited. Even if the connection terminals are linearly arranged in the longitudinal direction of the glass substrate 50, a necessary number of terminals for driving the exposure apparatus 13 can be ensured.

With the drive control unit 58 being properly positioned on the glass substrate 50, the glass substrate 50 is allowed to be significantly reduced in size in the short side direction (the sub-scanning direction) compared to the structure in which multiple IC chips are arranged in parallel to the row of light emitting elements; consequently, the image forming apparatus in which the exposure apparatus is mounted is downsized.

The present invention is described in detail above based on the embodiments of the present invention, particularly based on the current program technique. The nature of the present invention resides in placing the IC chips for controlling the drive of the light emitting elements or the interface unit for supplying signals to the substrate on which the light emitting elements are provided on the extended line of the row of light emitting elements, not in the structure intrinsic to the current program technique.

As an embodiment apart from the current program technique, for example, when the input image data transfer frequency exceeds the drive ability (operation frequency) of the TFT, an IC chip can be used to once receive image data transferred to the glass substrate in sync with a first high speed operation clock signals, divide the image data into multiple groups, and supply them to the TFT in sync with a second operation clock at a speed lower than the first operation clock. In such a case, needless to say, it is within the technical scope of the present invention that the IC chip used to divide the image data transferred to the glass substrate 50 can be placed on the extended line of the row of light emitting elements.

In the first and second embodiments, the IC chip for controlling the drive of the row of light emitting elements or the interface unit for supplying signals to the substrate on which the light emitting elements are provided is placed at a position on the glass substrate. These members can be placed at two positions on the extended line of the row of light emitting elements in the end of the glass substrate. If the IC chip is provided at both ends of the glass substrate in the longitudinal direction, the line capacitance can be reduced. Such a structure is particularly useful when the image forming apparatus carries an exposure apparatus elongated for the size A3.

In the first and second embodiments, the IC chip is placed on the extended line of the row of light emitting elements. Therefore, there are significant differences in the layout and wiring distance from the IC chip to light emitting elements between the light emitting elements at the end where the IC chip is provided and the light emitting elements at the other end. When the program time is problematically restricted by such differences for example because of a long row of light emitting elements, appropriate wiring techniques can be used to reduce the line resistance or line capacitance.

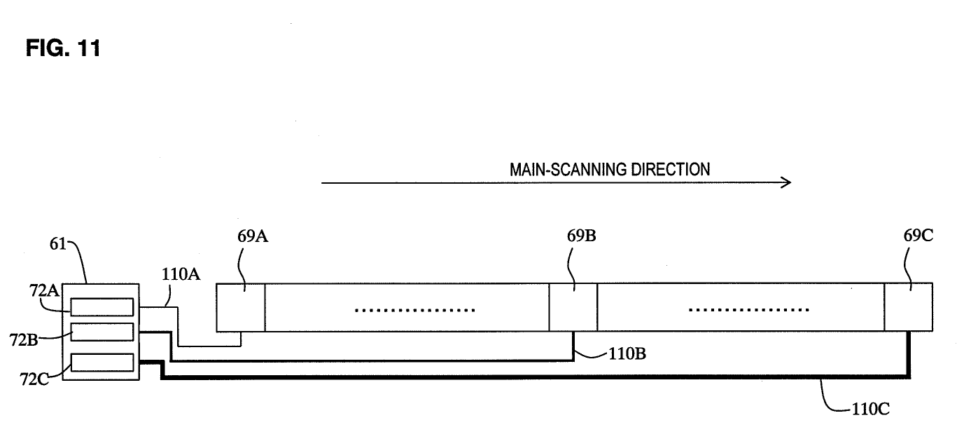

FIG. 11 is an illustration showing a structure of the source driver signal line. As described above, the multiple D/A converters 72 in the IC chip 61 are connected to multiple pixel circuits in each group to supply light amount correction data to the pixel circuits. In the embodiment of FIG. 11, in order to reduce the line resistance of the source driver signal line to supply light amount correction data, the pixel circuit signal line has a larger width as the distance of the pixel circuit from the IC chip or the signal source is increased.

FIG. 11 schematically shows pixel circuits linearly arranged in the main scanning direction along with organic EL elements. The IC chip 61 is placed near one end of the arrangement. Among the D/A converters in the IC chip 61, a D/A converter 72A is connected to a pixel circuit 69A that is the nearest from the IC chip 61 via a signal line 110A. A D/A converter 72C is connected to a pixel circuit 69C that is the farthest from the IC chip 61 via a signal line 110C. A D/A converter 72B is connected to a pixel circuit 69B that is between the pixel circuits 69A and 69C via a signal line 110B. The signal line width varies depending on the position of the pixel circuit in the main scanning direction, being increased in the order of the signal lines 110A, 110B, and 110C. The line resistance of the signal lines 110B and 110C is reduced by increasing the signal line width as the wire length from the signal source is increased. With the line resistance of the signal lines to the pixel circuits away from the IC chip 61 being reduced, the restriction on the program time can be reduced. If the program time can be reduced, the entire head performance (print speed) can be improved.

With the line width being varied as described above, nearly uniform line resistance can be obtained among the signal lines. Alternatively, the signal lines to some pixel circuits far away from the IC chip 61 including the pixel circuit 69C on the opposite end to the IC chip 61 can be increased in width by a fixed rate compared to the signal lines to the other pixel circuits. For example, relatively short signal lines such as the signal lines 110A and 110B have the same line width and relatively long signal lines such as the signal line 110C have a line width increased by a fixed rate.

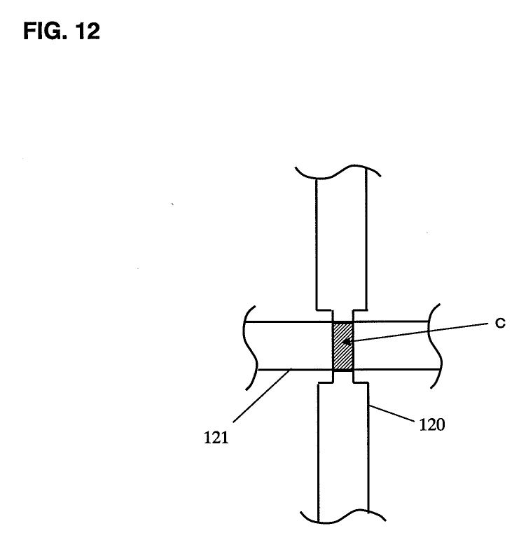

FIG. 12 is an illustration showing a structure of the crossing point of signal lines. Besides the source driver signal line, a program control signal line for supplying the signal SCAN_A from the gate controller 68, a light emission control signal line for supplying the signal SCAN_B, a power line, and a ground line are connected to the pixel circuit 69. These lines may cross each other due to the layout and generate capacitance elements between their layers. When the line capacitance elements are increased, the restriction on the program time is increased. In the embodiment of FIG. 12, among two crossing signal lines 120 and 121, one signal line 120 has a smaller line width at the crossing point C than in the rest in order to reduce the increase in the line capacitance at the crossing point C. In this way, the facing area of the signal lines 120 and 121 at the crossing point C is reduced. In order to reduce the facing area, the signal line 121 can have a smaller line width at the crossing point C than in the rest in place of or in addition to the signal line 120. In this way, at least one of the crossing signal lines can have a smaller line width at some or all crossing points than in the rest to reduce the line capacitance.

However, when the line width is reduced to reduce capacitance elements at the crossing point, the line resistance is increased there. Then, it is preferable to determine the signal line width at the crossing point C in consideration of both the capacitance elements and the line resistance. Furthermore, when the program signal line and other signal lines cross each other, only the other signal lines can have a smaller line width at the crossing point C. For example, when the signal line 110C crosses a signal line from the gate controller 68, only the signal line from the gate controller 68 can have a smaller width at the crossing point C than in the rest. In this way, influence on the program time is reduced. Alternatively, among crossing signal lines, only the shorter signal line can have a smaller width at the cross point C than in the rest.

The capacitance elements over the entire wiring can be reduced by reducing the number of signal line crossing pints. For example, in the structure shown in FIG. 6, the gate controller 68 is placed in parallel to the row of light emitting elements at one end of the glass substrate 50 in the width direction. The program control signal lines and light emission control signal lines are extended from the gate controller 68 to the pixel circuits. On the other hand, the IC chip 61 is placed at one end of the glass substrate 50 in the longitudinal direction. Therefore, when the source driver signal line is connected to the pixel circuits from the gate controller 68 side of the row of light emitting elements, the source driver signal line and the program control signal lines and light emission control signal lines tend to cross each other. In order to reduce the number of such crossing points, the connections of the signal lines from the IC chip and the signal lines from the gate controller 68 can be made in different directions seen from the pixel circuits. In the embodiment of FIG. 6, the source driver signal line from the IC chip is connected to the pixel circuit on the opposite side of the row of light emitting elements to the gate controller 68. In this way, a reduced number of crossing points lead to reduced capacitance elements over the entire wiring.

In the first and second embodiments, one IC chip is used to control the drive of the row of light emitting elements. Any number of IC chips can be used. Cost of the IC chip largely affects the yield. The chip cost is highly correlated to the chip area. The chip cost may be dramatically reduced as the chip area is reduced. In such a case, it is more advantageous to use multiple small area chips on a glass substrate. For example, the IC chips can be arranged on the glass substrate in the longitudinal direction.

The first and second embodiments are described above based on an image forming apparatus using the electrophotography. However, the present invention is not restricted to the electrophotography. Needless to say, since R, G, and B light sources are easily realized by organic EL elements, the present invention is applicable to an image forming apparatus in which multiple exposure apparatuses each having an R, G, or B light source as the exposure light source is provided and a printing paper is directly exposed based on R, G, and B color image data. Alternatively, the present invention can be applied to a monochromic image forming apparatus to downsize the image forming apparatus.

The above described embodiments do not restrict the technical scope of the present invention and, beside them, various modifications and applications are available within the scope of the present invention.

### INDUSTRIAL APPLICABILITY

As described above, since particularly a tandem-type color image forming apparatus is downsized, the image forming apparatus of the present invention is applicable for example to printers, copy machines, facsimiles, and photo-printers.

1. An image forming apparatus having an exposure apparatus, the exposure apparatus comprising:
a substrate;
a light emitting elements row containing a plurality of light emitting elements on the substrate; and
a drive control unit configured to receive from outside the substrate a control signal for driving the plurality of light emitting elements and control the drive of the plurality of light emitting elements based on the control signal, wherein the drive control unit is at least partly placed on an extended line of the light emitting elements row.

2. The image forming apparatus according to claim 1, wherein the drive control unit comprises:
an interface unit configured to receive at least the control signal from outside the substrate; and
an IC chip configured to control the drive of the plurality of light emitting elements based on the control signal received by the interface unit.

3. The image forming apparatus according to claim 1, wherein the drive control unit is placed without overlapping with the light emitting elements row in the direction of the light emitting elements row.

4. The image forming apparatus according to claim 1, wherein the drive control unit is placed at an end of the substrate on the extended line of the light emitting elements row.

5. An image forming apparatus having an exposure apparatus, the exposure apparatus comprising:
a substrate;
a light emitting elements row containing a plurality of light emitting elements on the substrate;
a drive circuit provided on the substrate and configured to supply a drive current to each of the plurality of light emitting elements of the light emitting elements row;
a drive parameter setting unit provided on the substrate and configured to set a drive parameter for driving the light emitting elements in the drive circuit; and
an interface unit provided on the substrate, coupled to the drive parameter setting unit, and configured to supply the drive parameter to the drive parameter setting unit from outside the substrate,
wherein at least either the drive parameter setting unit or the interface unit is placed on the extended line of the light emitting elements row.

6. The image forming apparatus according to claim 5, wherein the drive circuit includes a TFT (thin-film transistor).

7. The image forming apparatus according to claim 5, wherein the drive parameter setting unit is placed without overlapping with the light emitting elements row or the drive circuit in the direction of the light emitting elements row.

8. The image forming apparatus according to claim 5, wherein the drive parameter setting unit is an IC chip mounted on the substrate.

9. The image forming apparatus according to claim 5, wherein the drive parameter setting unit sets a current value for driving the light emitting elements in the drive circuit.

10. The image forming apparatus according to claim 1, wherein the substrate at least has a long side and short side, and the light emitting elements row is arranged in the long side direction of the substrate.

11. The image forming apparatus according to claim 1, wherein the light emitting elements are organic EL elements.

12. The image forming apparatus according to claim 1, wherein the substrate is a transparent substrate, and light emitted from the light emitting elements is transmitted through the transparent substrate before output.

13. The image forming apparatus according to claim 12, wherein the transparent substrate is a glass substrate.

14. The image forming apparatus according to claim 5, wherein the interface unit is placed without overlapping with the light emitting elements row or the drive circuit in the direction of the light emitting elements row.

15. The image forming apparatus according to claim 2, wherein the interface unit is directly mounted on the surface of the substrate.

16. The image forming apparatus according to claim 2, wherein the interface unit is mounted on the extended line of the light emitting elements row at the farthest part of the substrate.

17. An exposure apparatus comprising:
a substrate;
a light emitting elements row containing a plurality of light emitting element on the substrate; and
a drive control unit configured to receive from outside the substrate a control signal for driving the plurality of light emitting elements and control the drive of the plurality of light emitting element based on the control signal, wherein the drive control unit is at least partly placed on an extended line of the light emitting elements row.

18. An exposure apparatus comprising:
a substrate;
a light emitting elements row containing a plurality of light emitting elements on the substrate;
a drive circuit provided on the substrate and configured to supply a drive current to each of the plurality of light emitting elements of the light emitting elements row;
a drive parameter setting unit provided on the substrate and configured to set a drive parameter for driving the light emitting elements in the drive circuit; and
an interface unit provided on the substrate, coupled to the drive parameter setting unit, and configured to supply the drive parameter to the drive parameter setting unit from outside the substrate,
wherein at least either the drive parameter setting unit or the interface unit is placed on the extended line of the light emitting elements row.
